(19) United States
(12) Patent Application Publication
(10) Pub. No.: US 2009/0039548 A1
(43) Pub. Date: Feb. 12, 2009

(54) ROTATIONAL MOLDING TO FORM MULTILAYER ARTICLE

(75) Inventor: Robert L. Claussen, Benson, MN (US)

Correspondence Address: MUETING, RAASCH & GEBHARDT, P.A., P.O. BOX 581336, MINNEAPOLIS, MN, 55458-1336, US

(73) Assignee: Custom Roto-Mold, Inc., Benson, MN (US)

(21) Appl. No.: 11/835,731

(22) Filed: Aug. 8, 2007

(51) Int. Cl. B28B 7/28

(52) U.S. Cl. 264/255; 425/258; 425/435

(57) ABSTRACT

Apparatus, methods, and systems for rotational molding of a multilayer article, e.g., an article with a sight gauge, using a mold including a primary mold portion and a secondary mold portion.

### BACKGROUND

The present invention relates generally to rotational molding of a multilayer article, e.g., an article with a sight gauge. More particularly, the present invention relates to methods of rotational molding, rotational molding systems, and mold apparatus to use in the methods and systems of forming multilayered articles.

Rotational molding involves heating a flowable material in a hollow mold and rotating the mold to melt and distribute the material over the inside of the mold. Rotational molding is a high temperature, low pressure process and the strength required from the molds is minimal, which results in its ability to produce large, complex parts using a low-cost mold. Further, the low processing pressure involved in rotational molding has the added advantage of producing parts that are virtually stress free.

Rotational molded articles are used for many different commercial or consumer purposes including but not limited to livestock feeders, drainage systems, food service containers, instrument housings, fuel tanks, vending machines, highway barriers, road markers, boats, kayaks, childcare seats, light globes, tool carts, planter pots, playing balls, playground equipment, headrests, truck/cart liners, and air ducts.

Furthermore, although transparent sight gauges are common in small, blow-molded containers, e.g., motor oil containers, few methods for rotational molding an article with a sight gauge have been described. However, for example, U.S. Pat. No. 6,982,057, issued 3 Jan. 2006 to King et al. and entitled “Multi-layer Rotational Plastic Molding,” describes a method to create a transparent sight line in a molded article using a removable member. For example, described therein is a method and apparatus for manufacturing a multilayer plastic article having an area where an outside layer has a gap that reveals a separate inside layer. The outside layer may be optically opaque and the inside layer transparent, to provide a sight line for gauging the level of a container's contents. In U.S. Pat. No. 6,982,057, a first flowable material is introduced into a mold having an insulating member extending through an aperture or slot into the mold. The mold is rotated and heated to cure the material to a certain point. The insulating member is removed and a second flowable material is introduced into the mold through the aperture or slot. A cover member replaces the removed insulating member. The mold is rotated and heated to cure both materials, then cooled to extract the molded article.

However, such methods as described in U.S. Pat. No. 6,982,057 have disadvantages. For example, the mold must be removed from the oven to extract the insulating member from the aperture, introduce a second flowable material into the mold through the same aperture, and insert the cover member. Removal of the mold from the oven during rotational molding is disadvantageous for many reasons, e.g., energy is lost when the oven is opened, the process is interrupted, etc.

### SUMMARY

The present invention relates to a method, system, and apparatus for use in rotational molding a multilayered article, e.g., an article with a sight gauge.

In one embodiment of a mold apparatus according to the present invention for rotational molding of an article, the mold apparatus includes a primary mold portion and a secondary mold portion. The primary mold portion includes a thermally conductive material defining an interior volume. An aperture is defined through the primary mold portion to the interior volume. At least a portion of the secondary mold portion is positioned within the aperture of the primary mold portion. Further, the secondary mold portion includes a thermally conductive portion and a thermally insulative material. The thermally conductive portion includes at least a mold surface facing the interior volume of the primary mold portion. The thermally insulative material thermally insulates the thermally conductive portion of the secondary mold portion from at least the thermally conductive material of the primary mold portion when positioned in the aperture.

One embodiment of a method according to the present invention is used for rotational molding an article that includes at least a first layer of material defining at least part of an interior cavity and a second layer of material in the interior cavity. An opening is defined in the first layer of material and the second layer of material covers at least the opening defined in the first layer of material. The method includes providing a mold, introducing a first flowable material into the mold, heating and rotating the mold a first time, releasing a second flowable material into the mold, and heating and rotating the mold a second time. The mold includes a primary mold portion and a secondary mold portion. The primary mold portion includes a thermally conductive material defining an interior volume. An aperture is defined through the primary mold portion to the interior volume. At least a portion of the secondary mold portion is positioned within the aperture of the primary mold portion. Further, the secondary mold portion includes a thermally conductive portion and a thermally insulative material. The thermally conductive portion includes at least a mold surface facing the interior volume of the primary mold portion. The mold surface corresponds to the opening of the article. The thermally insulative material thermally insulates the thermally conductive portion of the secondary mold portion from at least the thermally conductive material of the primary mold portion. The first heating and rotating of the mold includes heating the primary mold portion while the secondary mold portion is thermally insulated therefrom and rotating the mold so as to lay down the first flowable material on the primary mold portion to form the first layer of material of the article while leaving the mold surface of the secondary mold portion free of the first flowable material. The second heating and rotating of the mold includes heating the thermally conductive portion of the secondary mold portion and the primary mold portion, and rotating the mold so as to lay down the second flowable material on the first layer of material of the article and on the mold surface of the secondary mold portion to form the second layer of material of the article.

In one embodiment of a system for rotational molding of an article, the system includes an oven, a mold to be used in the oven, a thermal treatment apparatus, a drop box to release material into the mold when the mold is in the oven, a manipulation apparatus to rotate the mold, and a control apparatus to control the system. The mold includes a primary mold portion and a secondary mold portion. The primary mold portion includes a thermally conductive material defining an interior volume. An aperture is defined through the primary mold portion to the interior volume. At least a portion of the secondary mold portion is positioned within the aperture of the primary mold portion. Further, the secondary mold portion includes a thermally conductive portion and a thermally insulative material. The thermally conductive portion includes at least a mold surface facing the interior volume of the primary mold portion. The thermally insulative material thermally insulates the thermally conductive portion of the secondary mold portion from at least the thermally conductive material of the primary mold portion when positioned in the aperture. The thermal treatment apparatus is fluidly coupled to the secondary mold portion for use in heating and/or cooling the thermally conductive portion of the secondary mold portion.

In another embodiment of a method for rotational molding of an article, the method includes providing an oven, providing a mold, introducing a first flowable material into the mold, positioning the mold inside the oven, heating and rotating the mold a first time, releasing a second flowable material into the mold, heating and rotating the mold a second time, and removing the mold from the oven. The mold includes a primary mold portion and a secondary mold portion. The primary mold portion defines an interior volume, and further defines at least a first and second aperture. At least a portion of the secondary mold portion is positioned within the first aperture of the primary mold portion. The first heating and rotating of the mold lays down the first flowable material on the primary mold portion to form a first layer of material of the article while leaving the secondary mold portion free of the first flowable material. Releasing the second flowable material into the mold through the second aperture in the primary mold portion is executed without removing the mold from the oven. The second heating and rotating of the mold lays down the second flowable material on the first layer of material and on the secondary mold portion to form a second layer of material of the article.

The above summary of the present invention is not intended to describe each embodiment or every implementation of the present invention. Advantages, together with a more complete understanding of the invention, will become apparent and appreciated by referring to the following detailed description and claims taken in conjunction with the accompanying drawings.

### BRIEF DESCRIPTION OF THE DRAWING

FIG. 1 is a perspective and illustrative view of an exemplary embodiment of a system for rotationally molding an article according to the present invention.

FIG. 2 is a perspective view of an exemplary embodiment of an article produced according to the present invention, e.g., with fluid contained therein, using a system such as shown in FIG. 1.

FIG. 3 is a perspective view of an exemplary embodiment of a primary mold portion according to the present invention used in a system such as shown in FIG. 1.

FIG. 4 is a perspective view of an exemplary embodiment of a secondary mold portion according to the present invention used in a system such as shown in FIG. 1.

FIG. 5A is an expanded cross-sectional view of the exemplary embodiment of the secondary mold portion of FIG. 4 taken along line B-B¹ according to the present invention.

FIG. 5B is an alternate embodiment of an expanded cross-sectional view of the exemplary embodiment of the secondary mold portion of FIG. 4 taken along line B-B¹ according to the present invention.

FIG. 5C is an expanded cross-sectional view of the exemplary embodiment of the secondary mold portion of FIG. 4 and FIG. 5A taken along line A-A¹ according to the present invention.

FIG. 5D is an enlarged, expanded partial cross-sectional view of the dashed circle portion of the exemplary embodiment of the secondary mold portion of FIG. 4 taken along line A-A¹ as shown in 5C according to the present invention.

FIG. 6 is a block diagram of an exemplary embodiment of a rotational molding method according to the present invention.

FIGS. 7A-7D are expanded partial cross-sectional views of FIG. 1 taken along line D-D¹ at different states of an exemplary method according to the present invention, such as that shown in FIG. 6.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention. Unless stated otherwise herein, the figures of the drawing are rendered primarily for clarity and thus may not be drawn to scale.

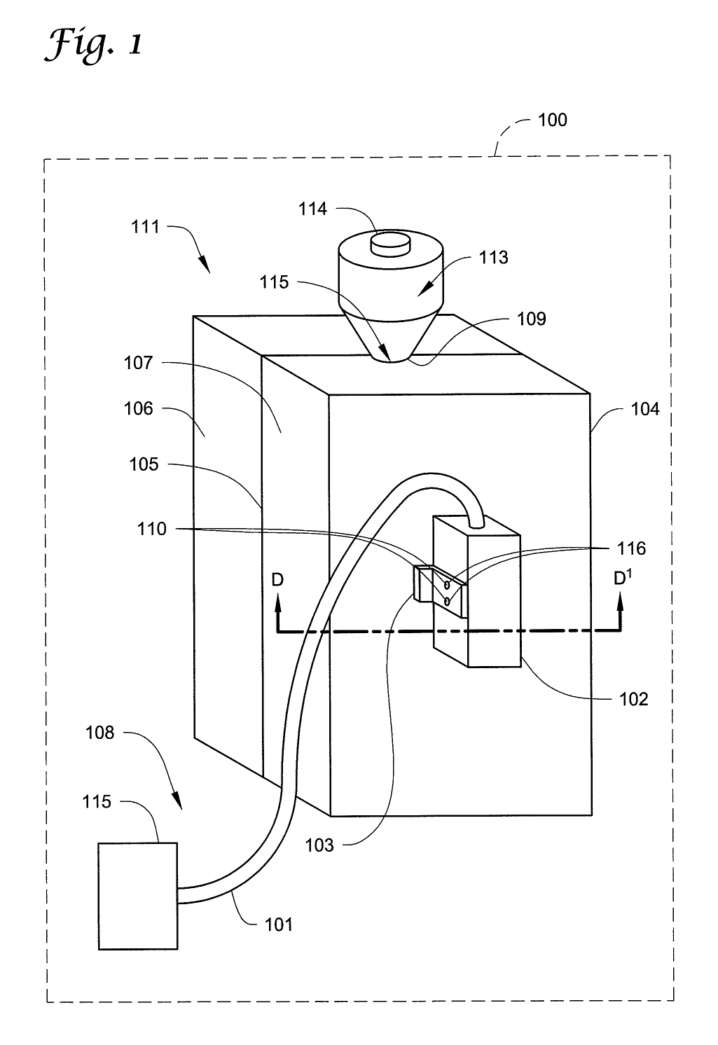

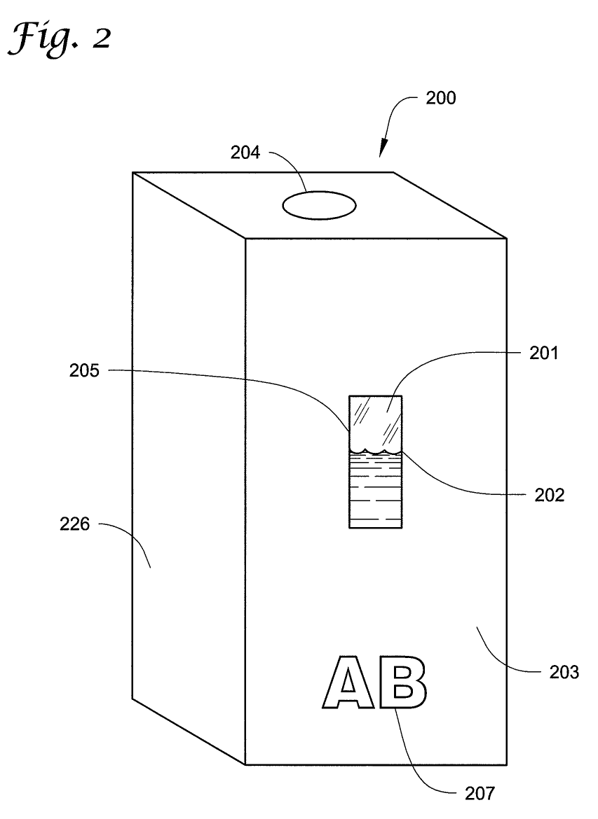

FIG. 1 shows a perspective and illustrative view of an exemplary embodiment of a system 100 for rotationally molding an article (e.g., article 200 shown in FIG. 2) according to the present invention. Multilayered articles can be useful for many reasons, functional and non-functional alike, including multicolored articles, articles with different colored lettering, articles with a non-reactive interior layer for use with abrasive contents, articles with different materials in each layer, and articles with translucent sight gauges. This description will describe the present invention in terms of an article with a translucent sight gauge; however, as shown above, an article with a translucent sight gauge is just one article that may be created with the present invention.

For example, in at least one embodiment, the article's layers are bonded together during rotational molding. In one embodiment, layers that are bonded may be defined as multiple layers forming a strong, uniform, and cohesive connection. Further, a sight gauge is defined as any translucent area of an object, e.g., within an otherwise opaque object, through which an outside viewer can view a portion of the interior volume of the article, e.g., for viewing the inside of a fuel tank to gauge how much fuel still resides in the tank. A translucent area is further defined as an area that permits at least some light to pass through so as to allow such viewing of the interior volume.

The system 100 includes a mold 111 that includes a primary mold portion 104 and a secondary mold portion 102, and further includes a secondary thermal treatment apparatus 108 to heat and/or cool at least a portion of the secondary mold portion 102. The system 100 further includes, as generally represented by the dashed line in FIG. 1, although not all specifically shown, a primary thermal apparatus to heat the mold 111 (e.g., an oven), a manipulation apparatus (e.g., to biaxially rotate the mold 111), a drop box 113, and a control system; as well as other components of any conventional rotational molding system as would be known to one skilled in the art.

Generally, the primary thermal apparatus to heat the mold 111 includes an oven, but the mold 111 may be heated by other thermal treatment apparatus known in the molding industry, e.g., a fluid reservoir surrounding the exterior mold surface for receiving hot fluid to heat the mold 111. Generally, in at least one embodiment, the oven has at least one opening to move the mold 111 in and out of the oven, and the oven is large enough so as to allow the manipulation apparatus to move and manipulate, e.g., rotate, the mold 111.

The manipulation apparatus of the system 100 may be used to biaxially rotate the mold 111 so as to evenly distribute a flowable material over the interior cavity of the mold 111. The manipulation apparatus may be equipped to handle one or more molds substantially simultaneously within the oven. This may be accomplished by the use of multiple arms and/or multiple molds attached to each arm. The manipulation apparatus may be powered by any method known in the mold industry, e.g., hydraulics, electric motor, and/or gas motor.

The drop box 113 may be used to introduce flowable material into the mold without removing the mold 111 from the primary thermal apparatus (e.g., oven). The drop box 113 is generally formed of thermally insulative material to thermally insulate its contents from the oven and has at least an opening 115, through which its contents may be released into the mold 111. The drop box 113 is generally fixed to either the mold 111 and/or the manipulation apparatus. Further, the drop box 113 may be tapered to the opening, i.e., a cone-shape, to facilitate disposal of all of the contents, or have any other suitable configuration.

In one embodiment, the drop box 113 may have an air-actuated opening 115 that corresponds to an opening in the mold 111 (e.g., a fill aperture 109 such as to form a fluid-fill opening 204 in an article 200 shown in FIG. 2), or may release the flowable material into the mold 111 using a different method other than an air-actuated opening. Generally, in one embodiment, when the opening 115 is opened, gravity pulls the contents out of the drop box 113 and into the mold 111. At least in one embodiment, the drop box 113 is opened while the manipulation apparatus is rotating the mold 111, and the drop box 113 is left open while the manipulation apparatus is still rotating the mold 111 for a fixed period of time. At least in another embodiment, the drop box 113 is opened when the manipulation apparatus pauses as to hold the mold 111 and drop box 113 in an upright, vertical position, and the drop box 113 closes after a fixed period of time wherein the manipulation apparatus continues rotation. However, the drop box 113 may dispose of its contents using any other suitable method as would be known by one having skill in the art. The drop box 113 may also include a second sealable opening 114 for filling the drop box 113.

A control system is used to control aspects of the system 100, such as, e.g., rotation speed, oven temperature, and/or drop box actuation. The control system may, for example, be an electronically based system, such as with use of digital or analog circuitry, a mechanically based system, and/or a manually based system. The control system may also have sensors that supply feedback to the control system itself or the users of the control system, e.g., a liquid crystal display, or analog dial. Further, the control system may be configured to receive input from users controlling the different aspects of the system through the use of a computer, and/or analog dials or switches. One will recognize that such control systems for rotational molding systems are available and may be modified to control the rotational molding of articles according to the present invention.

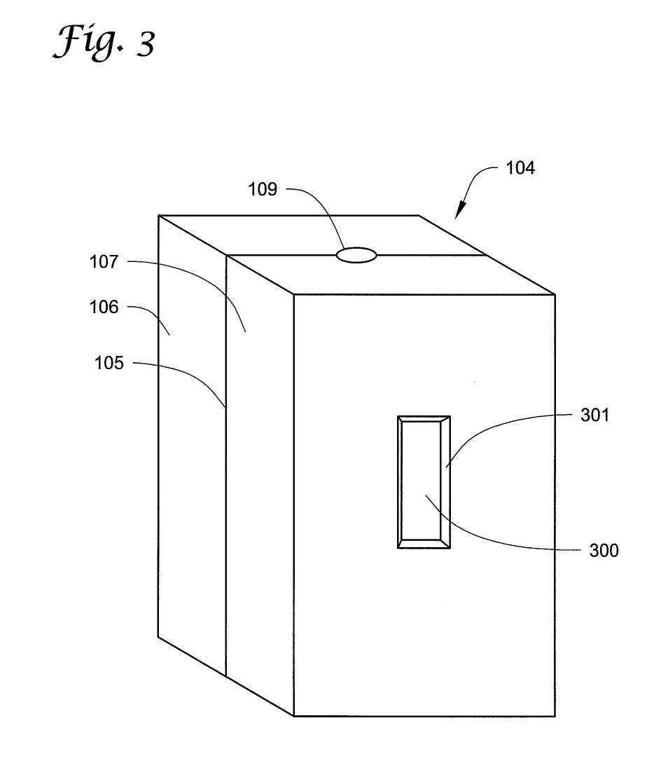

Generally, the mold 111 includes the primary mold portion 104 and the secondary mold portion 102. The secondary mold portion 102 partially resides in a secondary mold aperture 300 of the primary mold portion 104 shown in FIG. 3. The secondary mold portion 102 can be attached to the primary mold portion 104 in any manner as would be known to one skilled in the art. As shown in FIG. 1, a mounting boss 103 protrudes from the primary mold portion 104. The mounting boss 103 may be welded, mechanically affixed using coupling components to the primary mold portion 104. For example, the mounting boss 103, as shown in FIG. 1, includes anchor apertures 116 through which thermally insulative anchors 110 may be inserted to secure the secondary mold portion 102 at a position within the secondary mold aperture 300 (described below with reference to FIG. 3) of the primary mold portion 104. Further, for example, the secondary mold portion 102 can be securely attached to the primary mold portion 104 using a strap and/or latch.

As shown in FIG. 1 and FIG. 3, the primary mold portion 104 has a first half 106 and a second half 107. Parting line 105 is where the first half 106 and the second half 107 of the mold 111 meet to close the mold 111. When the mold 111 is removed from the oven, the mold halves 106/107 may be taken apart to remove the article 200. The mold halves 106/107 may be attached to each other by bolts and/or clamps. Further, the primary mold portion 104 may include any number of mold portions and is not limited to mold halves. For instance, it is not uncommon for a rotational mold to have more than two portions.

Also, a fill aperture 109 is defined by the mold 111 for forming a corresponding fluid-fill opening 204 in the article. Also, at least in one embodiment, the fill aperture 109 is used to introduce flowable material into the mold 111 using the drop box 113. The drop box 113 may introduce the flowable material into the mold 111 while the mold 111 is stationary in an upright position or rotating as would be known to one skilled in the art.

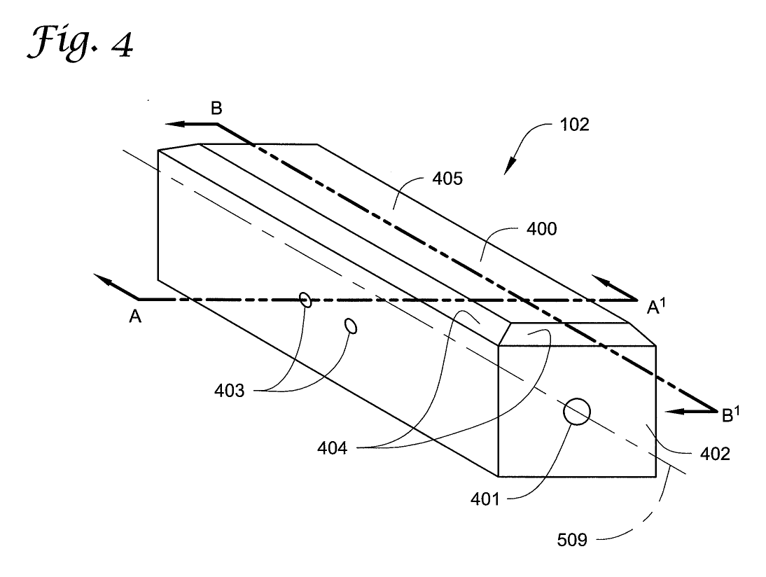

The secondary mold portion 102 according to the present invention used in the system 100 such as shown in FIG. 1 includes a thermally conductive portion and a thermally insulative material, such as will be described in further detail with reference to the exemplary secondary mold portion 102 shown in FIG. 4. The thermally conductive portion includes a thermally conductive interior mold surface that faces the interior of the mold 111 when assembled with the primary mold portion 104 (e.g., is substantially planar with the interior surface of the primary mold portion 104). The thermally insulative material insulates the thermally conductive portion from at least the primary mold portion 104, and further, in at least one embodiment, from the heat of the oven when the mold 111 is heated and rotated (e.g., the thermally insulative material may surround the thermally conductive portion except for the thermally conductive interior mold surface and an inlet port as shall be described further herein.

The secondary thermal treatment apparatus 108 may be used to heat and/or cool the thermally conductive portion of the secondary mold portion 102. For example, the secondary thermal treatment apparatus 108 can heat and/or cool the thermally conductive portion (e.g., a thermally conductive portion 400 shown in FIG. 4) of the secondary mold portion 102 through the use of heated and/or cooled fluid that is pumped through the transmission line 101. As used herein, “fluid” may refer to a liquid, gas, or any other flowable composition that can transfer energy between conductive materials. In one or more embodiments, the thermal treatment apparatus may use a coil of copper to heat and/or cool the fluid either inside of an oven and/or a cooling chamber. Although not shown, the secondary thermal treatment apparatus 108 is connected to and controlled by the control system presented generally by dashed line system 100 of FIG. 1. Block 115 may be one or more components that may be utilized by the secondary thermal treatment apparatus 108 as would be known by one having skill in the art.

In at least one embodiment, the secondary thermal treatment apparatus 108 may include an air compressor located outside of the oven that is connected to the manipulation apparatus (inside of the oven) of the system 100. The manipulation apparatus may include a transmission line that extends through the arm or arms of the manipulation apparatus to the mold 111. The transmission line may include a copper coil, and the copper coil, in turn may connect to the secondary mold portion 102. Instead of a copper coil, the transmission line may include a portion formed of any thermally conductive material, such as, e.g., steel. In this embodiment, the air compressor would be actuated to move air through the transmission line. The copper coil may be hot or cold depending on whether the mold is being heated or cooled. The copper coil may be heated or cooled by the temperature inside of the oven or cooling chamber. Consequently, when air moves through the copper coil, the air may be heated or cooled by the copper coil. The copper coil may be connected to the thermally insulative material of the secondary mold portion 102 so that the copper coil does not transmit energy to the thermally conductive portion of the secondary mold portion 102.

FIG. 2 illustrates a perspective view of an exemplary embodiment of an article produced according to the present invention, e.g., with fluid contained therein, using the system 100 such as shown in FIG. 1. In this embodiment, the article 200 is a rectangular box shape; however, article 200 can be of any shape or size as is possible using rotational molding as would be known to one skilled in the art.

Article 200, as shown in FIG. 2, includes a fluid-fill opening 204, a translucent sight gauge 205, a second layer 201, and a first layer 203. Although not readily apparent in FIG. 2, article 200 is two layers with the second layer 201 formed in the interior of the first layer 203, except in the area of the translucent sight gauge 205. The two layers substantially may form a single layer because a second flowable material that forms the second layer 201 is introduced before the first layer 203 is completely, or even partially, cured as is further described herein. Therefore, the layers may cure together to form a strong, uniform, and cohesive bond.

In at least one embodiment, the two layers may be formed of flowable material that may not cure together to substantially form a single layer. For example, the first layer may cure before the second flowable material is introduced.

The fill aperture 109 of the primary mold portion 104 corresponds to the fluid-fill opening 204 of the mold 111. Further, article 200 can include any number of additional apertures. These apertures, including the fluid-fill opening 204, can be used for any purpose (e.g., including attached of a drop box) and manner as would be known to one skilled in the art. For example, additional apertures may be used during the production or post production of the article, such as filling, draining, introducing flowable materials, and/or venting.

The translucent sight gauge 205 of the article 200 corresponds (e.g., in size and/or shape) to the secondary mold aperture 300 of the primary mold portion 104 as shown in FIG. 3. Translucent sight gauge 205 is formed by the second layer 201. In this embodiment, a fluid level 202 in the interior of the article 200 is shown. Translucent sight gauge 205 can be of any shape, size, and color as desired. Further, the article 200 can have multiple sight gauges.

The system 100 according to the present invention may form features other than sight gauges or windows, e.g., the system 100 may form lettering 207 within the article 200 as shown in FIG. 2. The lettering may be of any shape, size, and color as desired. In this embodiment, letters “AB” (i.e., lettering 207) are shown, but any combination of letters would be possible. Like the translucent sight gauge, the lettering 207 is formed by the second layer 201 in substantially the same way as the sight gauge was formed, i.e., with a secondary mold portion that may be heated or cooled independently of the primary mold portion.

Article 200 can be designed to hold many different types of materials, e.g., liquids, gases, and/or solids.

FIG. 3 illustrates a perspective view of an exemplary embodiment of the primary mold portion 104 according to the present invention used in a system such as shown in FIG. 1. As previously indicated, the primary mold portion 104 includes the first half 106, the second half 107, the secondary mold aperture 300, and the fill aperture 109. The primary mold portion 104 defines an interior volume for use in forming the article 200.

The primary mold portion 104 may be formed from any material that is thermally conductive and can withstand the temperatures required for rotational molding as would be known to one skilled in the art. For example, the primary mold portion 104 may be formed of cast aluminum, CNC-machined aluminum, and/or electroformed or fabricated sheet metal (stainless steel, mild steel, nickel). In one embodiment, the primary mold portion 104 is formed of aluminum. At least in one embodiment, the thickness of the walls of the primary mold portion 104 is about 1/16 inch to about ½ inch.

Secondary mold aperture 300 corresponds to a thermally conductive interior mold surface 405 of the secondary mold portion 102, such as shown in FIG. 4. Secondary mold aperture 300 can be of any shape or size as desired to form the translucent sight gauge 205 in any shape or size as desired. Secondary mold aperture 300 includes a bevel 301. The secondary mold aperture bevel 301 is an angled surface extending between the exterior surface to the interior surface of the primary mold portion 104 (i.e., angled towards the center of the opening 300 with the opening at the exterior surface being greater than the opening at the interior surface of the mold 111), which corresponds to a thermally insulative bevel 404 of the secondary mold portion 102 (described below with reference to FIG. 4). The secondary mold aperture bevel 301 provides snug fitting and/or precise placement for the secondary mold portion 102 within the secondary mold aperture 300 of the primary mold portion 104.

FIG. 4 illustrates a perspective view of one exemplary embodiment of the secondary mold portion 102 according to the present invention used in the system 100 such as shown in FIG. 1. The secondary mold portion 102 includes the thermally conductive portion 400 and a thermally insulative material 402.

The thermally conductive portion 400 includes the thermally conductive interior mold surface 405. The thermally conductive interior mold surface 405 is the portion of the secondary mold portion 102 that faces the interior of the mold 111 when assembled with the primary mold portion 104. When the mold 111 is assembled, i.e., when the secondary mold portion 102 is coupled to the primary mold portion 104, at least in one embodiment, the thermally conductive interior mold surface 405 is substantially planar with the interior surface of the primary mold portion 104. These interior surfaces are substantially planar as to form a translucent sight gauge that is substantially planar to the exterior and interior surfaces of the article 200 (e.g., translucent sight gauge 205).

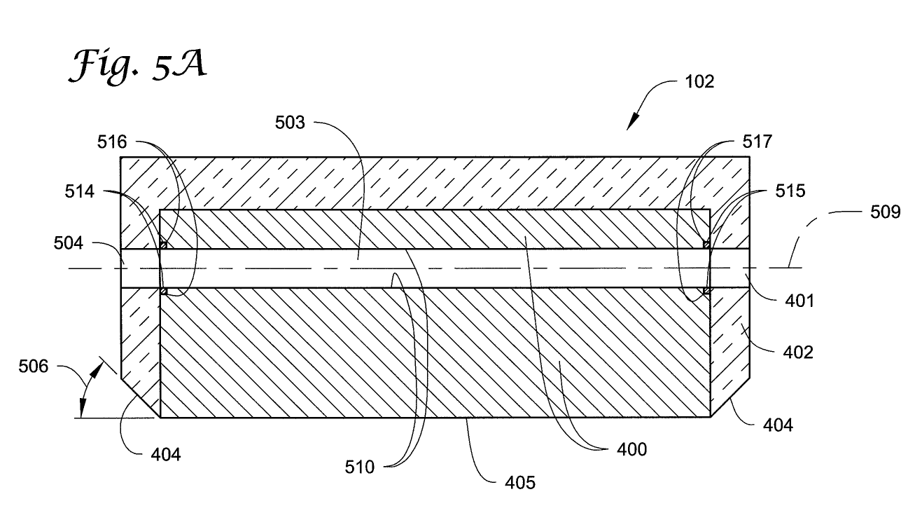

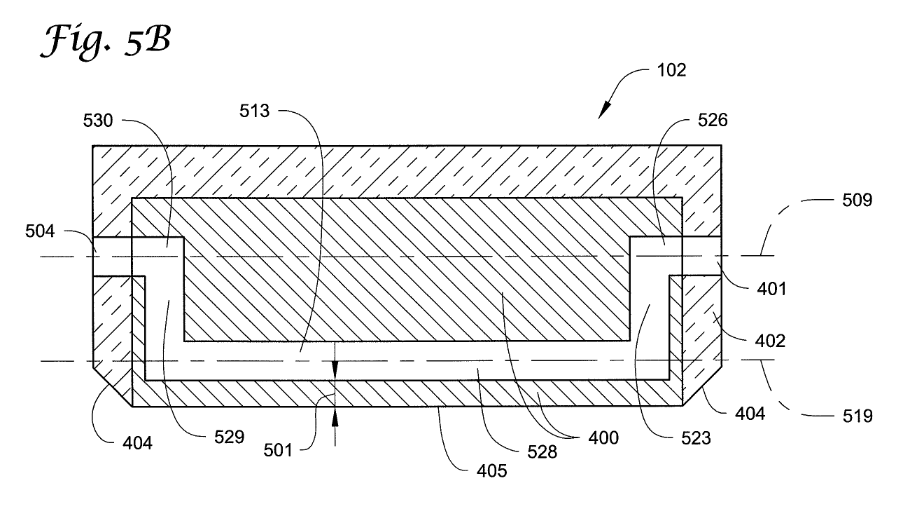

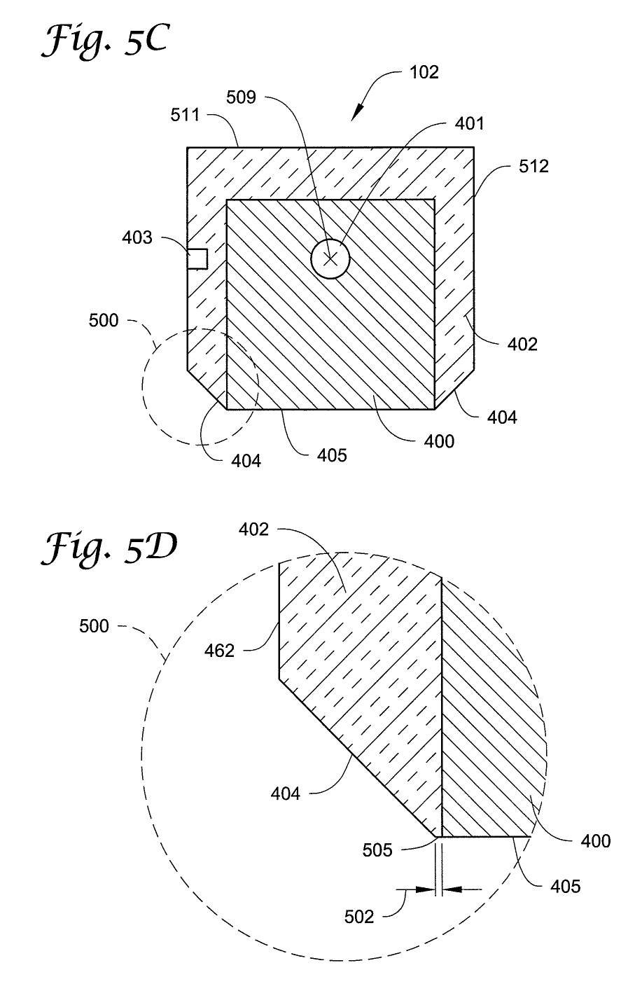

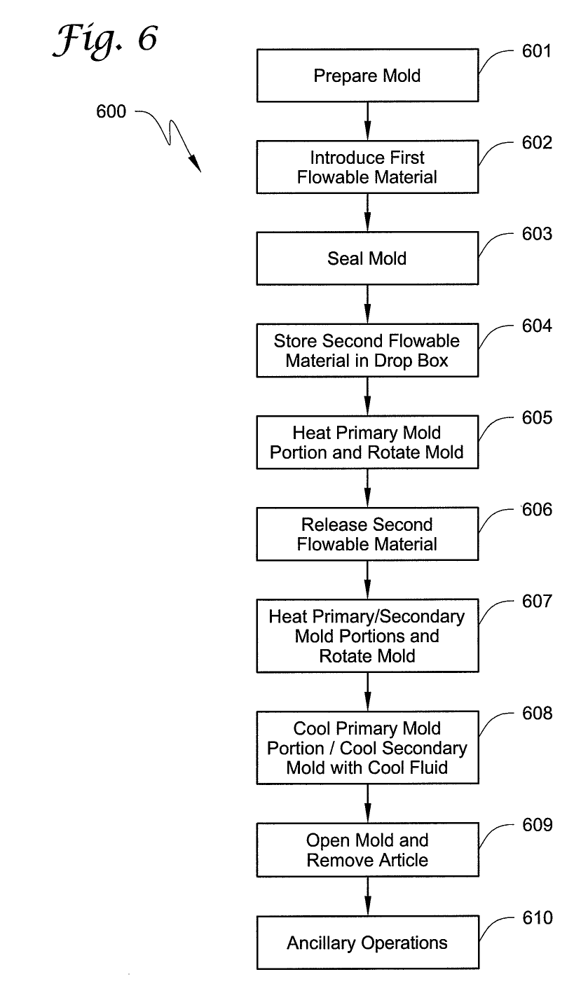

Thermally insulative material 402 insulates the thermally conductive portion 400 from at least the primary mold portion 104, and further, in at least one embodiment, from the heat of the oven when the mold 111 is heated and rotated. As shown, the thermally insulative material 402 may, at least in one embodiment, surround the thermally conductive portion 400 except for the thermally conductive interior mold surface 405 and an inlet port 401. The inlet port 401 is an opening through the thermally insulative material 402 to a passageway (e.g., passageway 503 of FIG. 5A) through a least a portion of the thermally conductive portion 400 for receiving hot and/or cold fluid from the thermal treatment apparatus 108 to heat and/or cool the thermally conductive portion 400. The inlet port 401 connects to the transmission line 101, such as shown in FIG. 1 to receive hot and/or cold fluid from the thermal treatment apparatus 108 to heat and/or cool the thermally conductive portion 400. The thermally insulative material 402 further includes an outlet port (e.g., outlet port 504 of FIG. 5A) that connects to the end of a passageway (e.g., the passageway 503 of FIG. 5A).

As shown in FIG. 4, the thermally insulative material 402 further includes, in at least one embodiment, anchor apertures 403, and/or the thermally insulative bevel 404. The anchor apertures 403 of the thermally insulative material 402 correspond to the anchor apertures 116 of the mounting boss 103 of the primary mold portion 104. The thermally insulative anchors 110, as shown in FIG. 1, connect the mounting boss 103 to the anchor apertures 403 of the secondary mold portion 102. The anchor apertures 403 may extend through the thermally insulative material 402 into the thermally conductive portion 400. The use of the thermally insulative anchors 110 further maintains the thermally conductive portion 400 being insulated from the primary mold portion 104.

The thermally insulative bevel 404 is an angled surface extending between the exterior surface of the insulative material 402 to a thermally insulative interior surface 505 as described herein, for example, with reference to FIG. 5D. In one embodiment, the thermally insulative bevel 404 corresponds to the secondary mold aperture bevel 301 of the primary mold portion 104 as shown in FIG. 3 to provide a snug fit, precise placement, and/or effective thermal insulation between the secondary mold portion 102 and the primary mold portion 104.

FIG. 5A illustrates an expanded cross-sectional view of an exemplary embodiment of the secondary mold portion 102 as shown in FIG. 4 taken along line B-B¹ according to the present invention. As shown, the thermally insulative material 402 surrounds the thermally conductive portion 400 except for the thermally conductive interior mold surface 405, the inlet port 401, and the outlet port 504. Except for the thermally insulative bevel 404, in at least one embodiment, the thickness of the thermally insulative material 402 is about ¼ inch to about ¾ inch.

O-rings 516, 517 may be inserted between the thermally conductive portion 400 and the thermally insulative material 402. The thermally conductive portion 400 may have a grooves 514, 515 proximate the inlet port 401 and the outlet port 504 within which the O-rings 516, 517 may be located. In at least one embodiment, the grooves may be within the thermally insulative material 402. Further, in at least one embodiment, O-rings may not be utilized between the thermally insulative material 402 and the thermally conductive portion 400, e.g., see the alternative embodiment depicted in FIG. 5B.

The thermally conductive interior mold surface 405 faces the interior portion of the mold 111 when the secondary mold portion 102 is assembled with the primary mold portion 104. In one embodiment, as shown in FIG. 5A, the inlet port 401 connects to the outlet port 504 by the substantially straight passageway 503 along an axis 509. A portion of the passageway 503 is defined by thermally conductive bore sidewalls 510, which extend through the thermally conductive portion 400 of the secondary mold portion 102. When hot or cold fluid is pumped through the passageway 503, energy is transferred between the thermally conductive bore sidewalls 510 and the hot or cool fluid, which, in effect, heats or cools the thermally conductive portion 400 of the secondary mold portion 102. The passageway 503 may have a bore of any shape or configuration, e.g., a square or a circle. In at least one embodiment, a square bore may be used so as to increase turbulence of the hot or cold fluid to increase energy transfer between the thermally conductive portion 400 and the fluid. Increased fluid turbulence can be helpful when heating or cooling the secondary mold portion 102, particularly portions of large size. However, the passageway 503 may be of any suitable shape and/or configuration.

In at least one embodiment, the thermally insulative bevel 404 may have any angle 506 that is suitable to provide a snug fit, precise placement, and/or effective thermal insulation as would be known by one having skill in the art. In at least one embodiment, as shown in FIG. 5A, the angle 506 is about 45 degrees.

The thermally insulative material 402, as shown in FIG. 5A, is formed from one piece of thermally insulative material. However, the thermally insulative material 402 may be formed of multiple pieces of a thermally insulative material coupled together in any manner as would be known to one skilled in the art (e.g., bolted together, adhesive, etc.). Thermally insulative material 402 may be formed of any suitable thermally insulative substance that can substantially thermally insulate conductive material during rotational molding as would be known to one skilled in the art. For example, the thermally insulative material 402 may be formed from TEFLON® (Polytetrafluoroethylene), available from DuPont.

FIG. 5B illustrates an expanded cross-sectional view of an alternate exemplary embodiment of the secondary mold portion 102 taken along line B-B¹ of FIG. 4 according to the present invention. In this embodiment, the passageway 513 of the thermally conductive portion 400 of the secondary mold portion 102 runs closer to the thermally conductive interior mold surface 405 of the thermally conductive portion 400.

More specifically, as shown in FIG. 5B, the passageway 513 first connects to the inlet port 401 and an inlet portion 526 extends through a portion of the thermally insulative material 402 and a portion of the thermally conductive portion 400 along the axis 509. Then, the inlet portion 526 of the passageway 513 turns towards the thermally conductive interior mold surface 405 and extends towards it (e.g., portion 523 of the passageway 513). A parallel portion 528 of the passageway 513 extends parallel along a substantial portion of the thermally conductive interior mold surface 405 along an axis 519, e.g., parallel to the axis 509. The passageway 513 then extends away from the thermally conductive interior mold surface 405 (e.g., a portion 529 of the passageway 513) to connect to an outlet portion 530 of the passageway 513 that extends through the outlet port 504. In at least one embodiment, distance 501, the distance between the thermally conductive interior mold surface 405 and the surface closest that defines the passageway 513, may be about ¼ inch to about 1.5 inches.

This passageway configuration shown in FIG. 5B may heat and/or cool the thermally conductive interior mold surface 405 at a faster rate and with less energy due to the lesser amount of material between the parallel portion 528 of the passageway 513 and the thermally conductive interior mold surface 405. Also, the squared corners, i.e., the 90 degree turns, of the passageway 513 increase turbulence of the fluid, which increases energy transfer as described herein.

Furthermore, the passageway through the secondary mold portion 102 can exist in many configurations. For example, the passageway can extend back-and-forth throughout the thermally conductive portion 400 to create a radiator-coil-like structure for thermal uniformity across the thermally conductive interior mold surface 405, or any other suitable configuration for providing, e.g., an increased rate of heating and/or cooling.

FIG. 5C illustrates an expanded cross-sectional view of an exemplary embodiment of the secondary mold portion 102 of FIG. 4 and FIG. 5A taken along line A-A¹ according to the present invention. In this embodiment, the anchor aperture 403 is shown extending into the thermally insulative material 402 for mating with the thermally insulative anchors 110 to secure the secondary mold portion 102. However, although not shown, the anchor apertures 403 may extend into the thermally conductive portion 400 of the secondary mold portion 102. Also, the anchor apertures 403 can be located on any exterior surface of the secondary mold portion 102, e.g., a top surface 511, or an opposite side surface 512 (i.e., opposite the surface with the anchor aperture 403 in FIG. 5C).

FIG. 5D illustrates an enlarged, expanded cross-sectional view of the dashed circle portion 500 as shown in FIG. 5C of the exemplary embodiment of the secondary mold portion 102 of FIG. 4 taken along line A-A¹ according to the present invention. In this illustration, the thermally insulative bevel 404 is shown in greater detail. The thermally insulative bevel 404 is an angled surface extending between an exterior surface 462 of the thermally insulative material 402 to a thermally insulative interior surface 505. As shown, the thermally insulative interior surface 505 is substantially planar with the thermally conductive interior mold surface 405. The thermally insulative interior surface 505 may be provided to maintain a minimum insulative distance 502 between the primary mold portion 104 and the thermally conductive portion 400 of the secondary mold portion 102 when assembled.

In at least one embodiment, the distance 502 between the thermally conductive portion 400 of the secondary mold portion 102 and the primary mold portion 104, i.e., the width of the thermally insulative interior surface 505, may be about 30/1000 of an inch or greater, about 60/1000 of an inch or greater, or about 90/1000 of an inch or greater. In at least one embodiment, distance 502 may be about 150/1000 of an inch or less, about 130/1000 of an inch or less, or about 110/1000 of an inch or less. However, the distance 502 may vary depending on the temperature of fluid, the temperature of the oven, the flowable material, the thermally insulative material 402, the material of the primary mold portion 104, the material of the thermally conductive portion 400, the size of the sight gauge 205, etc. In view of these changing variables, the distance 502 may vary but may be larger than or equal to the minimum distance by which substantial insulation can be achieved between the primary mold portion 104 and the thermally conductive portion 400 of the secondary mold portion 102, and, be smaller than or equal to the maximum distance by which flowable material can bridge the gap created by the thermally insulative interior surface 505 during the molding process.

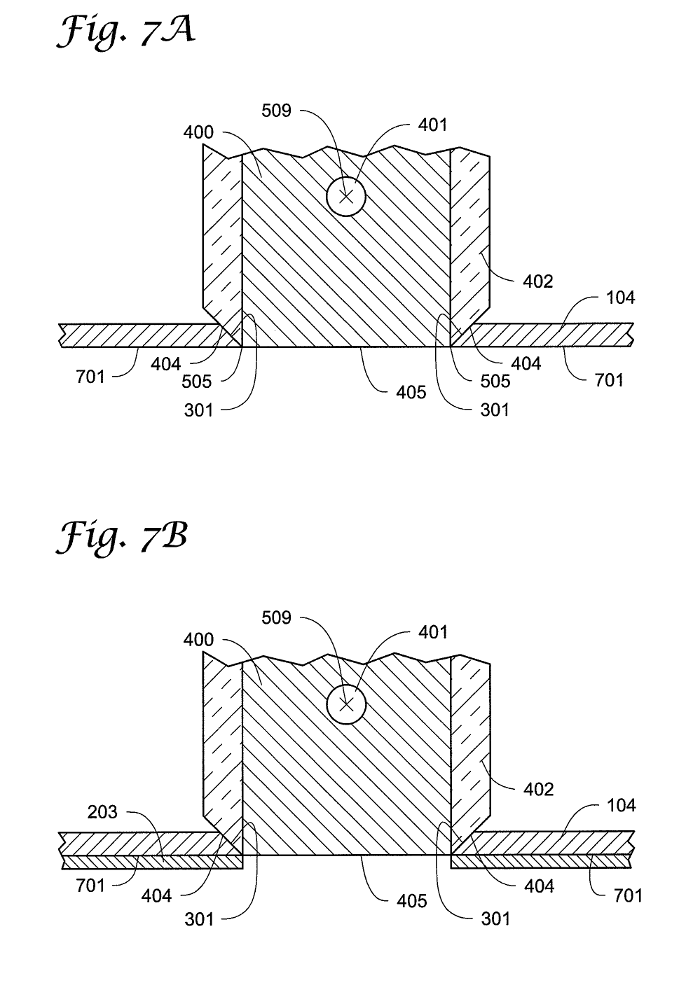

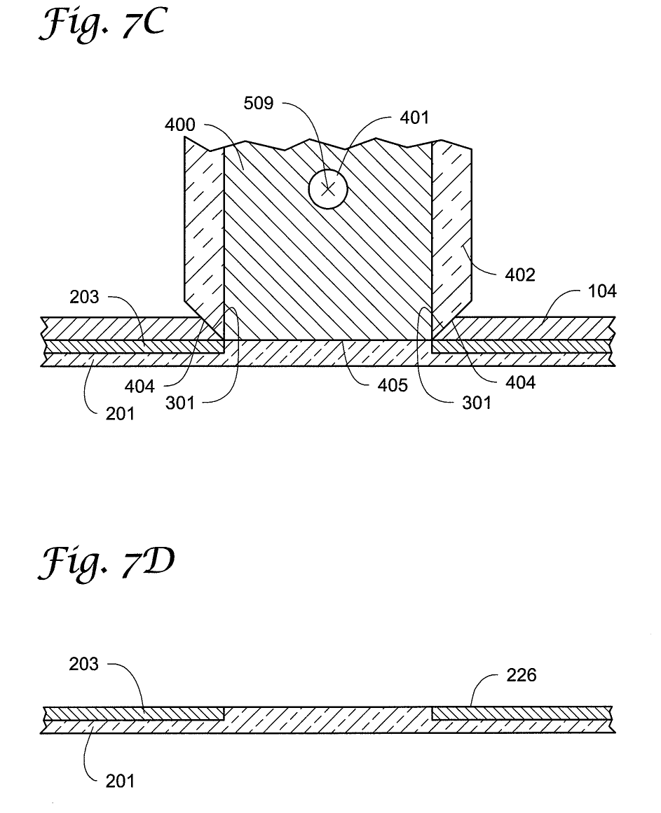

FIG. 6 is a block diagram of an exemplary embodiment of a rotational molding method 600 according to the present invention. The method 600 shall be described with further reference to the illustrative drawings shown in FIGS. 7A-7D, as well as FIG. 1.

In block 601, the mold, such as the mold 111 shown in FIG. 1, is prepared. Preparing the mold may include forming the primary mold portion 104, forming the secondary mold portion 102, assembling the primary mold portion 104, assembling the secondary mold portion 102, coupling the secondary mold portion 102 to the primary mold portion 104, coupling the assembled mold 111 to the manipulation apparatus and/or any other step as would be known to one skilled in the art.

The primary mold portion 104 and the secondary mold portion 102 may be formed by a computer numerical control (CNC) milling machine and/or any other suitable machining manner known to one skilled in the art. Further, in at least one embodiment, the thermally insulative bevel 404 of the secondary mold portion 102, and the secondary mold aperture 300 of the primary mold portion 104 may be machined with very high precision, e.g., about 5/1000 of an inch to about 100/1000 of an inch, so as to maintain snug fit, precise placement, and/or effective thermal insulation between the thermally insulative bevel 404 of the secondary mold portion 102 and the secondary mold aperture 300 of the primary mold portion 104. For example, a portion of the primary mold portion 104 that defines the aperture 300 may be precision machined and then coupled to the remainder of the primary mold portion 104.

In block 602, a first flowable material is introduced into the mold 111. The first flowable material can be introduced into the assembled mold 111 either manually and/or automatically. The first flowable material, as well as other flowable materials described herein, may be formed of polyethylene. However, any other material as would be known to one skilled in the art can suffice, such as nylons, low density polyethylene (LDPE), linear low density polyethylene (LLDPE), polypropylene, ethylene vinyl acetate (EVA), and/or polyvinyl chloride (PVC). Generally, the flowable materials are naturally translucent. Therefore, to achieve a colored layer, color pigments may be added. The first layer 203 may be an opaque color to protect its contents from electromagnetic radiation. The flowable material may be in powder form, pellet form, bead form, and/or any other form that is suitable for rotational molding.

The mold 111 is sealed in block 603. Sealing the mold may include closing the mold 111 by adjoining the first half 106 and the second half 107. The mold halves 106/107 may be attached to each other by bolts and/or clamps.

Further, before the mold 111 is inserted into the oven for thermal treatment, a second flowable material is stored in the drop box 113 mounted outside of the mold 111 (block 604). The second flowable material, at least in one embodiment, is formed of polyethylene, but can be any material as would be known to one skilled in the art, such as the materials described herein for the first flowable material. The second flowable material may be a translucent color so that when it forms the second layer 201, it allows at least some light to pass so that it may function as a sight gauge.

Use of drop boxes is known in the art and will not be described in detail herein. For example, the drop box 113 as illustratively shown in FIG. 1 may have an air-actuated opening that corresponds to the fill aperture 109 of the primary mold portion 104 (as shown in FIG. 1 and FIG. 3), or any other opening corresponding to an opening in an article being molded.

In block 605, the mold is heated (e.g., heated in an oven) and rotated (e.g., biaxially rotated to form the first layer 203 of article 200). After suitable rotation at a suitable temperature, the first layer 203 is formed on the primary mold portion 104. However, the first layer 203 may not be completely cured as to enhance the bond between the first layer 203 and the second layer 201 to be formed.

During the formation of the first layer, no material may be formed on the interior mold surface 405 of the secondary mold portion 102 because, during this step, the interior mold surface 405 of the secondary mold portion 102 is not heated and is insulated from primary mold portion 104, as well as the temperature of the oven applied to the primary mold portion 104. Depending on the size of the mold, properties of the materials, and complexity of the article, the heating time, temperature, and rotation speed may vary as would be known to one skilled in the art. In at least one embodiment, the thickness of the first layer 203, formed of the first flowable material, may be about 100/1000 of an inch to about 375/1000 of an inch.

After the first layer is formed (block 605), while the mold 111 is still in the oven, the drop box 113 is actuated to release the second flowable material into the mold 111 (block 606). In block 607, while still in the oven (e.g., the mold 111 continually residing in the oven during the formation both the first and second layers), the mold 111 is heated and rotated biaxially to form a second layer. At this point, the first layer 203 has not fully cured so as to enhance the bond between the first layer 203 and the second layer 201. The secondary thermal treatment apparatus 108 heats the interior mold surface 405 of the secondary mold portion 102 by flowing (e.g., pumping) a heated fluid through the transmission line 101. In at least one embodiment, the temperature of the heated fluid may be in the range of about 450 degrees Fahrenheit to about 625 degrees Fahrenheit, which, in turn, heats the thermally conductive interior mold surface 405 to a temperature in the range of about 450 degrees Fahrenheit to about 625 degrees Fahrenheit. To achieve a substantially planar interior surface of the article 200, more material may be formed about the secondary mold portion 102 to fill the void left by the first layer 203. After suitable rotation at a suitable temperature, the second layer 201 is formed on the first layer 203, the thermally conductive interior mold surface 405 of the secondary mold portion 102, and the thermally insulative interior mold surface 505. In at least one embodiment, the thermally conductive portion 400 of the secondary mold portion 102 may be heated to a higher temperature that the primary mold portion 104. However, in other embodiments, the thermally conductive portion 400 of the secondary mold portion 102 may be heated to the same temperatures as the primary mold portion 104.

Block 606 and block 607 may occur substantially simultaneously so as to introduce the second flowable material before the first layer cures so as to create a strong, cohesive, and uniform bond, or any other suitable purpose as would be known to one skilled in the art.

In block 608, the mold is cooled. Cooling the mold may include cooling the primary mold portion 104 and/or cooling the secondary mold portion 102. Generally, fans are used to cool the mold, however, other cooling techniques may be used as would be known to one skilled in the art. For example, the mold 111 may be moved into a cooling chamber that may include fans and/or water vapor. However, the conditions for cooling the primary mold portion 104 may depend on the article being formed.

The thermal treatment apparatus 108 may be used to cool the secondary mold portion 102 by pumping cool fluid through the transmission line 101 to the secondary mold portion 102. In at least one embodiment, the transmission line 101 may include a copper coil, and the copper coil, in turn may connect to the secondary mold portion 102. The copper coil may be cooled by the temperature inside of the cooling chamber. Consequently, when air moves through the copper coil, the air may be cooled by the copper coil. The cool air may then cool the thermally conductive portion 400 of the secondary mold portion 102.

In block 609, the mold 111 is opened and the article 200 is removed from the mold 111 in any manner as would be known to one skilled in the art.

In block 610, ancillary operations are performed to the article, such as trimming and/or buffing.

Furthermore, although the present invention has only been described herein to include two mold portions and two flowable materials, an additional secondary mold portion and a third flowable material may be included with the present invention so as to create an article with a third layer and/or an additional feature, such as a sight gauge or lettering. Moreover, any number of secondary mold portions and flowable materials may be used to created multilayer articles with many layers and/or features. Also, a secondary mold portion may also contain an additional mold portion within itself so as to create a feature within a feature, such as a sight gauge with lettering.

FIGS. 7A-7D illustrate expanded, partial cross-sectional views of FIG. 1 taken along line D-D¹ at different stages of an exemplary method according to the present invention, such as that shown in FIG. 6.

FIG. 7A illustrates the secondary mold portion 102 assembled with the primary mold portion 104 such as would be present upon completion of block 601 of the method shown in FIG. 6. When assembled, no gap exists between the thermally insulative bevel 404 of the secondary mold portion 102 and the secondary mold aperture bevel 301 of the primary mold portion 104. Further, the thermally conductive interior mold surface 405 and the thermally insulative interior mold surface 505 (shown best in FIG. 5D) both of the secondary mold portion 102 are substantially planar with an interior surface 701 of the primary mold portion 104. As shown, the mold 111 is ready for the introduction of the first flowable material into the mold 111 and for thermal treatment, e.g., insertion into the oven, such as blocks 602-604 of the method shown in FIG. 6.

FIG. 7B illustrates the secondary mold portion 102 assembled with the primary mold portion 104 after the first layer 203 has formed on the interior surface 701 of the primary mold portion 104. First layer 203 is formed on the interior surface 701 of the primary mold portion 104 leaving the interior mold surface 405 of the secondary mold portion 102 free of the first layer 203, such as would be present upon completion of block 605 of the method shown in FIG. 6. The first layer 203 is not formed on the thermally conductive interior surface 405 of the secondary mold portion 102 because it is not heated and remains cool because it is thermally insulated from the heat of the oven and the primary mold portion 104.

FIG. 7C illustrates the secondary mold portion 102 assembled with the primary mold portion 104 after the second layer 201 has formed on the thermally conductive interior mold surface 405 of the secondary mold portion 102 and the first layer 203, and bridged the gap between the primary mold portion 104 and the secondary mold portion 102 (e.g., the thermally insulative interior mold surface 505), such as would be present upon completion of block 607 of the method shown in FIG. 6. The second layer 201 may form, as shown, a substantially planar interior surface of the article 200.

The temperature of the thermally conductive interior mold surface 405 of the secondary mold portion 102 may directly relate to the amount of material formed on it. Therefore, the thickness of the portion of the second layer 201 formed on the thermally conductive interior mold surface 405 of the secondary mold portion 102 can be varied if desired (e.g., by varying the temperature of the thermally conductive interior mold surface 405). In this example, no material had formed on the secondary mold portion 102 until the second flowable material was introduced. Therefore, the second flowable material may fill-in the region left free of the first flowable material shown in FIG. 7B, as well as form the thickness of the rest of the second layer 201. To maintain a substantially planar interior surface, the thermally conductive interior mold surface 405 may be heated to a higher temperature than the primary mold portion 104 so as to more quickly provide for the formation of the second layer 203 from the second flowable material on the secondary mold portion 102, which, in turn, accumulates more of the second layer 201 on the interior mold surface 405 of the secondary mold portion 102. However, in at least one embodiment the thermally conductive interior mold surface 405 may be heated to the same temperature as the primary mold portion 104. In such cases, the second layer 201 formed from the second flowable material on the secondary mold portion 102 still accumulates more quickly on the secondary mold portion 102 because the first layer 203 provides insulation to the further formation of the second layer 201 on first layer 203. Therefore, in this embodiment, the formation of the second layer 201 on the first layer 203 may take longer than the formation of the second layer 201 on the interior mold surface 405 of the secondary mold portion 102, which allows for a thicker second layer 201 over the interior mold surface 405.

FIG. 7D illustrates a cross-sectional view of a sidewall 226 of the article 200 after removal from the mold 111, such as would be present upon completion of block 609 of the method shown in FIG. 6. The first layer 203 and the second layer 201 are substantially integral as the layers cure together to create a strong bond. Further, the article sidewall 226 is substantially planar on both the exterior and interior sides.

The complete disclosure of the patents, patent documents, and publications cited in the Background, the Summary, the Detailed Description of Exemplary Embodiments, and elsewhere herein are incorporated by reference in their entirety as if each were individually incorporated. Exemplary embodiments of the present invention are described above. Those skilled in the art will recognize that many embodiments are possible within the scope of the invention. Other variations, modifications, and combinations of the various components and methods described herein can certainly be made and still fall within the scope of the invention. Thus, the invention is limited only by the following claims and equivalents thereto.

What is claimed is:

1. A method for rotational molding of an article, wherein the article comprises at least a first layer of material defining at least part of an interior cavity, wherein an opening is defined in the first layer of material, and further wherein the article comprises a second layer of material in the interior cavity covering at least the opening defined in the first layer of material, wherein the method comprises:
providing a mold comprising:
a primary mold portion comprising a thermally conductive material defining an interior volume, wherein an aperture is defined through the primary mold portion to the interior volume; and
a secondary mold portion, wherein at least a portion of the secondary mold portion is positioned within the aperture of the primary mold portion, and further wherein the secondary mold portion comprises:
a thermally conductive portion comprising at least a mold surface facing the interior volume of the primary mold portion, wherein the mold surface corresponds to the opening of the article; and
a thermally insulative material to thermally insulate the thermally conductive portion of the secondary mold portion from at least the thermally conductive material of the primary mold portion;
introducing a first flowable material into the mold;
heating the primary mold portion, with the secondary mold portion thermally insulated therefrom, and rotating the mold so as to lay down the first flowable material on the primary mold portion to form the first layer of material of the article while leaving the mold surface of the secondary mold portion free of the first flowable material;
releasing a second flowable material into the mold; and
heating the thermally conductive portion of the secondary mold portion and the primary mold portion, and rotating the mold so as to lay down the second flowable material on the first layer of material of the article and on the mold surface of the secondary mold portion to form the second layer of material of the article.

2. The method according to claim 1, wherein heating the primary mold portion comprises heating the primary mold portion in an oven, and further wherein the thermally conductive portion of the secondary mold portion is thermally insulated from heat of the oven during the laying down of the first flowable material.

3. The method according to claim 1, wherein heating the primary mold portion to lay down the first flowable material comprises introducing the mold into an oven, and further wherein the mold is not removed from the oven until after formation of the second layer of the article.

4. The method according to claim 1, wherein introducing the second flowable material into the mold and heating the thermally conductive portion of the secondary mold portion are performed approximately simultaneously.

5. The method according to claim 1, wherein releasing the second flowable material into the mold comprises using a drop box to release the second flowable material into the mold through an opening in the mold corresponding to a fluid-fill opening of the article.

6. The method according to claim 1, wherein releasing the second flowable material into the mold comprises using a drop box to release the second flowable material into the mold while the mold is in an oven.

7. The method according to claim 1, wherein the thermally insulative material of the secondary mold portion is formed about the thermally conductive portion of the secondary mold portion except for the mold surface thereof.

8. The method according to claim 1, wherein the thermally insulative material comprises Teflon.

9. The method according to claim 1, wherein heating the thermally conductive portion of the secondary mold portion comprises using a fluid to transfer heat to the thermally conductive portion of the secondary mold portion.

10. The method according to claim 1, wherein the method further comprises cooling the primary mold portion and the secondary mold portion prior to removal of the article from the mold, wherein cooling the thermally conductive portion of the secondary mold portion uses a fluid to transfer heat away from the thermally conductive portion of the secondary mold portion.

11. The method according to claim 1, wherein the secondary mold portion defines:
an inlet port for receiving a fluid for use in heating and/or cooling the thermally conductive portion of the secondary mold portion;
an outlet port for discharging the fluid; and
a passageway in the secondary mold portion connecting the inlet port and the outlet port.

12. The method according to claim 1, wherein the article comprises a fluid holding container and the opening defined in the first layer of material corresponds to an elongated sight line to allow a user to observe the level of fluid in the container.

13. The method according to claim 1, wherein the method comprises positioning the secondary mold portion within the aperture defined by the primary mold portion such that the mold surface of the secondary mold portion is separated from the primary mold portion by a distance in the range of about 30 thousandths to about 150 thousandths of an inch.

14. A mold apparatus for rotational molding of an article comprising:
a primary mold portion comprising a thermally conductive material defining an interior volume, wherein an aperture is defined through the primary mold portion to the interior volume; and
a secondary mold portion, wherein at least a portion of the secondary mold portion is positioned within the aperture of the primary mold portion, and further wherein the secondary mold portion comprises:
a thermally conductive portion comprising at least a mold surface facing the interior volume of the primary mold portion; and
a thermally insulative material to thermally insulate the thermally conductive portion of the secondary mold portion from at least the thermally conductive material of the primary mold portion when positioned in the aperture.

15. The mold apparatus according to claim 14, wherein the thermally insulative material of the secondary mold portion surrounds the thermally conductive portion thereof except for the mold surface of the thermally conductive portion facing the interior volume of the primary mold portion.

16. The mold apparatus according to claim 14, wherein the article comprises a fluid holding container comprising a sight line and the aperture defined through the primary mold portion corresponds to the sight line within the fluid holding container.

17. The mold apparatus according to claim 14, wherein the thermally insulative material of the secondary mold portion comprises Teflon.

18. The mold apparatus according to claim 14, wherein the secondary mold portion defines:
an inlet port for receiving a fluid for use in heating and/or cooling the thermally conductive portion of the secondary mold portion;
an outlet port for discharging the fluid; and
a passageway in the secondary mold portion connecting the inlet port and the outlet port.

19. The mold apparatus according to claim 18, wherein the passageway is configured to allow the fluid to contact at least a part of the thermally conductive portion of the secondary mold portion.

20. The mold apparatus according to claim 14, wherein the secondary mold portion is positioned within the aperture defined by the primary mold portion such that the mold surface of the secondary mold portion is separated from the primary mold portion by a distance in the range of about 30 thousandths to about 150 thousandths of an inch.

21. The mold apparatus according to claim 14, wherein an interior surface of the primary mold portion bordering the aperture and the mold surface of the secondary mold portion facing the interior volume are planar.

22. A system for rotational molding of an article, comprising:
an oven;
a mold to be used in the oven, comprising:
a primary mold portion comprising a thermally conductive material defining an interior volume, wherein an aperture is defined through the primary mold portion to the interior volume; and
a secondary mold portion, wherein at least a portion of the secondary mold portion is positioned within the aperture of the primary mold portion, and further wherein the secondary mold portion comprises:
a thermally conductive portion comprising at least a mold surface facing the interior volume of the primary mold portion; and
a thermally insulative material to thermally insulate the thermally conductive portion of the secondary mold portion from at least the thermally conductive material of the primary mold portion when positioned in the aperture;
a thermal treatment apparatus, wherein the thermal treatment apparatus is fluidly coupled to the secondary mold portion for use in heating and/or cooling the thermally conductive portion of the secondary mold portion;
a drop box to release material into the mold when the mold is in the oven;
a manipulation apparatus to rotate the mold; and
a control apparatus to control the system.

23. A method for rotational molding of an article, wherein the method comprises:
providing an oven;
providing a mold comprising:
a primary mold portion defining an interior volume, the primary mold portion further defining at least a first and second aperture; and
a secondary mold portion, wherein at least a portion of the secondary mold portion is positioned within the first aperture of the primary mold portion;
introducing a first flowable material into the mold;
positioning the mold inside the oven;
heating and rotating the mold so as to lay down the first flowable material on the primary mold portion to form a first layer of material of the article while leaving the secondary mold portion free of the first flowable material;
releasing a second flowable material into the mold through the second aperture in the primary mold portion without removing the mold from the oven;
heating and rotating the mold so as to lay down the second flowable material on the first layer of material and on the secondary mold portion to form a second layer of material of the article; and
removing the mold from the oven.

24. The method according to claim 23, wherein a thermally conductive portion of the secondary mold portion is thermally insulated from heat of the oven during the laying down of the first flowable material.

25. The method according to claim 23, wherein a thermally insulative material surrounds a thermally conductive portion of the secondary mold portion except for a mold surface of the thermally conductive portion facing the interior volume of the primary mold portion.

26. The method according to claim 23, wherein the article comprises a fluid holding container and an opening in the first layer of material comprises an elongated sight line to allow a user to observe the level of fluid in the container.
